(19) United States
(12) Patent Application Publication
(10) Pub. No.: US 2007/0280481 A1
(43) Pub. Date: Dec. 6, 2007

(54) Method and apparatus for multiple pre-shared key authorization

(76) Inventors: Donald E. Eastlake, Milford, MA (US); George A. Harvey, Marlborough, MA (US); Minh N. Hoang, Stoughton, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/447,429

(22) Filed: Jun. 6, 2006

(51) Int. Cl. H04L 9/00

(52) U.S. Cl. 380/277

(57) ABSTRACT

A system and method of providing security in a wireless network is provided. A plurality of pre-shared keys is created. Each pre-shared key provides access to the wireless network. A list of the plurality of pre-shared keys is transmitted to an access point device in the wireless network so that the access point device can authenticate a station attempting to access the network by performing an analysis with the list of the plurality of pre-shared keys.

### BACKGROUND

1. Field

A system and method are generally disclosed with relate to network security.

2. General Background

Networks have recently become more widespread in smaller environments such as the home, home office, and small office. While these networks have mechanisms in place to provide for secure access by a single class of authorized users, they do not adequately address the security concerns raised by wireless access of temporary users, such as visitors, or users with other access limitations.

The simplest authentication mechanism that is currently used is a Pre-Shared Key (“PSK”) that is manually entered into each device. The existing PSK standards are relatively simple and only provide for a single PSK to be installed in all stations (“STAs”) and Access Points (“APs”) that are part of the network.

However, configuring temporary access for a visitor on a station in the network can become quite cumbersome. A manual re-keying of all the other devices in the network is needed so that the other devices have a new key, to terminate the visitor's access, e.g., upon departure. Such manual re-keying can in many circumstances present significant challenges. For instance, there may be many devices in a network such as a small office network. Re-keying a number of devices could be quite time consuming and expend resources. Further, some of the devices in the network may be wireless devices that are not often in the vicinity of the network. Requiring the devices outside of the general vicinity to be brought back for manual re-keying would also expend resources.

Another problem with the single PSK is that there is no authenticated way to distinguish different stations. If the stations could be distinguished from one another, a station could be given limited access. For instance, the restricted station could be given Internet access, but could be blocked from communicating with other local stations.

A second authentication mechanism is a Public Key Infrastructure (“PKI”) which is far more complex than the PSK. In general terms, the PKI involves authentication through digital certificates. An Authentication, Authorization, and Accounting (“AAA”) server is usually utilized with the PKI system. Establishing this type of system is generally too complex for a network that is utilized in a home, home office, or small office. The difficulties of establishing PKIs and distributing certificates have been a major stumbling block in the deployment of secure mail, IP security, and many security standards that are, in practice, PKI dependent, even for large and capable organizations, let alone the manager of the home, home office, or small office network.

The third authentication mechanism is a split security regime, which allows some stations to run securely and other stations to run without being secured. The split security regime raises a number of problems.

One problem is that broadcast traffic, such as packets from the Address Resolution Protocol (“ARP”) and Dynamic Host Configuration Protocol (“DHCP”), must be sent in the least secure mode to assure that all stations can receive it. If the stations that are secure for unicast traffic are also secured for broadcast traffic, then that traffic must be sent twice, once secured and once insecure. Since broadcast traffic generally has to be sent at the lowest bit rate in any case to be sure all stations receive it, sending it at this low bit rate twice uses up significant channel time. Alternatively, the “secure” stations could be configured to be insecure for broadcast traffic, but then they would be subject to forged broadcast messages.

Another problem is that such a split scheme provides only two classes, one of which provides distinctly inferior insecure usage. This might be appropriate for some visitors but is clearly unsatisfactory if several classes of secure users that can be independently terminated or whose access is limited in different ways are desired.

The final problem is that the support of insecure stations means the network is running open to access by drive by hackers, etc. This is clearly an undesirable effect.

Accordingly, the current technologies provide unworkable solutions. The manager of the home, small business, or small office network is unable to implement a simple mechanism that is secure.

### SUMMARY

In one aspect of the disclosure, a method of providing security in a wireless network is provided. A plurality of pre-shared keys is created. Each pre-shared key provides access to the wireless network. A list of the plurality of pre-shared keys is transmitted to an access point device in the wireless network so that the access point device can authenticate a station attempting to access the network by performing an analysis with the list of the plurality of pre-shared keys.

In another aspect of the disclosure, a method of providing access to a wireless network is provided. A list of a plurality of pre-shared keys is received from a controller. Further, a request is received from a station for access to the wireless network. In addition, information that is dependent on a station pre-shared key is received from the station. Further, the pre-shared key is authenticated by performing an analysis on the information that is dependent on the pre-shared key and the list of the plurality of pre-shared keys. Finally, access to the wireless network is granted if the pre-shared key is authenticated.

In yet another aspect of the disclosure, a method of securely accessing a wireless network is provided. Access is requested to the wireless network. Further, information that is dependant on a pre-shared key is provided to authenticate the pre-shared key. In addition, the wireless network is accessed upon receiving authentication that the shared key is present on a list of a plurality of pre-shared keys.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 illustrates a block diagram of a station or system that attempts to connect to the wireless network.

FIG. 2 illustrates a system which utilizes an authentication mechanism with multiple PSKs.

FIG. 3 illustrates a process in which a list of multiple PSKs is generated.

FIG. 4 illustrates a process in which a pre-shared key is authenticated.

FIG. 5 illustrates a process for accessing a wireless network.

FIG. 6 illustrates a system in which the controller is incorporated into the Access Point.

FIG. 7 illustrates a four way hand shake process.

### DETAILED DESCRIPTION

A method and apparatus are provided that provide secure access in a wireless network in a home, home office, or small office. Multiple PSKs are generated to reduce the inconvenience of re-keying all the stations other than those whose access is to be terminated and to avoid implementing an overly complex infrastructure. A list of a plurality of PSKs can be maintained so that upon a connection attempt by a user, it can be determined whether the user's pre-shared key is in the list of the plurality of PSKs.

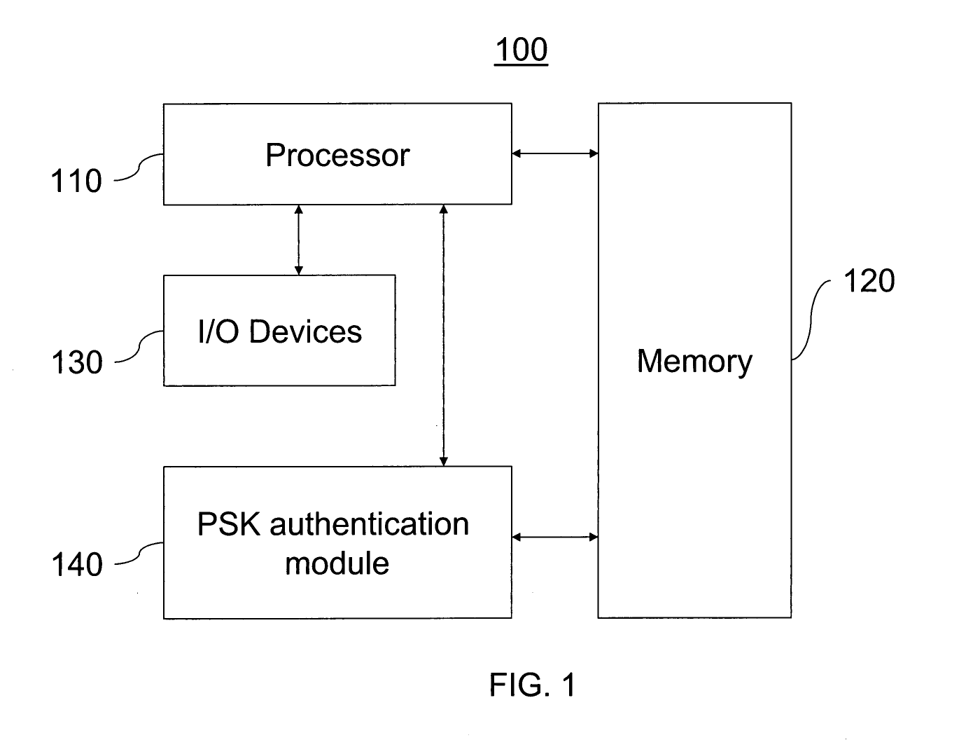

FIG. 1 illustrates a block diagram of a station or system 100 that attempts to connect to the wireless network. In one embodiment, the station or system 100 is implemented using a general purpose computer or any other hardware equivalents. Thus, the station or system 100 comprises a processor (CPU) 110, a memory 120, e.g., random access memory (RAM) and/or read only memory (ROM), PSK authentication module 140, and various input/output devices 130, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the PSK authentication module 140 can be implemented as one or more physical devices that are coupled to the CPU 110 through a communication channel. Alternatively, the PSK authentication module 140 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 120 of the computer. As such, the PSK authentication module 140 (including associated data structures) of the present invention can be stored on a computer readable medium, e.g., RAM memory, magnetic or optical drive or diskette and the like.

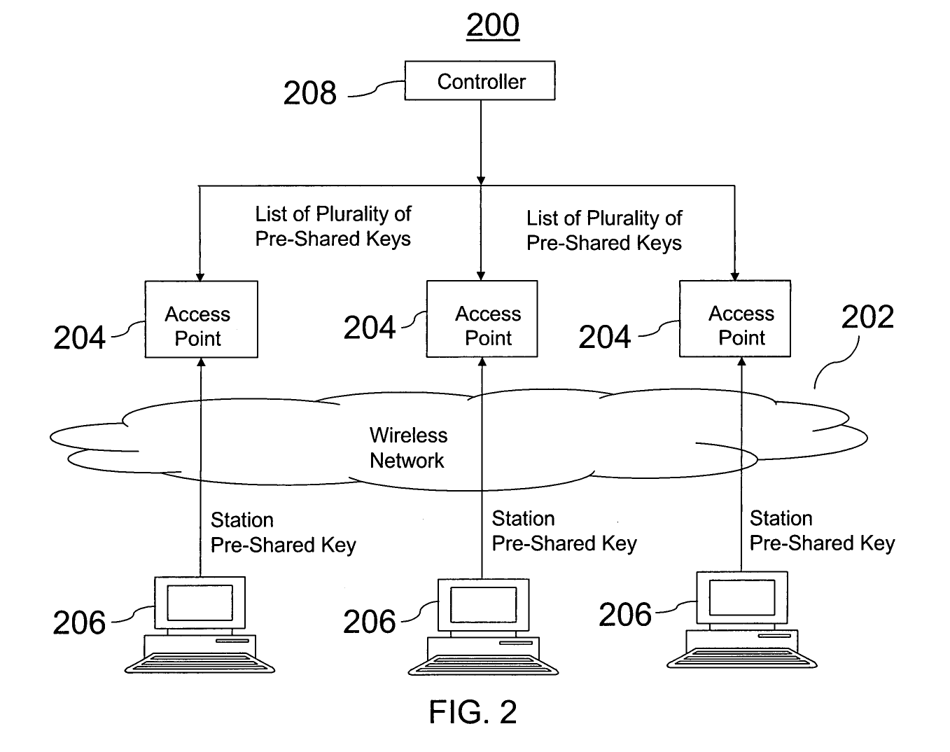

FIG. 2 illustrates a system 200 which utilizes an authentication mechanism with multiple PSKs. In one embodiment, a network manager is authenticated to a network through the manual installation of an initial PSK with infinite lifetime. One of ordinary skill in the art will recognize that there are various other ways in which the network manager can be authenticated to the network.

In the system 200, a controller 208 contains a list of plurality of pre-shared keys. The network manager, having already been authenticated to the network as described above, interacts with the controller 208 to maintain the list of multiple PSKs. In one embodiment, the network manager interacts with the network through a web interface. To assure high quality random PSKs, the PSK itself may be generated by the controller 208 with a human recognizable name for the PSK provided by the network manager.

The controller 208 can be implemented as software, hardware, or both. For instance, the controller 208 can be a software program or function that runs in a web page. The controller 208 can also be a hardware device that receives input and/or provides output. Further, the controller can be a server that includes a hardware device for running a server program. One of ordinary skill in the art will recognize a variety of devices and/or programs that can be used for the controller 208.

The list of plurality of pre-shared keys is transmitted from the controller 208 to at least one Access Point 204. When a user station 206 requests access to a wireless network 202, the user station 206 provides information that is dependent on a station pre-shared key to the access point 204. The Access Point 204 compares the information that depends on the station pre-shared key with information that depends on each of the PSKs in the list of multiple PSKs. If it is determined from this comparison of PSK-dependant information that the station pre-shared key is present on the list of multiple PSKs, the Access Point 204 provides access to the wireless network 202 to the user station 206. However, the access that the Access Point provides to the user station 206 may be limited.

The Access Point 204 reviews the list of multiple PSKs to determine if there are any limitations on the user of the authenticated key. There may be restrictions on the type of access given to the user for the key. For example, rules associated with a key assigned to a visitor user may limit the user's access to the wireless network 202 to Internet access. There may also be time restrictions on the key. For example, a visitor user may receive a key with access that expires at the end of the day. Accordingly, each key on the list of multiple PSKs may have a validity expiration date/time. Alternatively or in combination, each key on the list of multiple PSKs may also have a validity start date/time or other chronological limitations, such as being usable only on Wednesdays.

In one embodiment, the list of multiple PSKs is transmitted from the controller 208 to the Access Point 204 through the wireless network 202. In another embodiment, the list of multiple PSKs is transmitted to the Access Point 204 through a hard wired network connection. In this embodiment, the user stations 206 can still communicate with the Access Point 204 to obtain access to the wireless network 202.

A plurality of Access Points 204 can be utilized. Further, each of the Access Points 204 can communicate with a plurality of user stations 206.

Entries may be added or deleted from the list of multiple PSKs. For instance, after a visitor user has left, his or her key may be deleted from the list of multiple PSKs. Further, if a visitor user is going to be coming to a site, an entry may be added to the list of multiple PSKs. Accordingly, the list of multiple PSKs that is sent to the Access Point 204 may need to be updated to reflect additions and/or deletions to the list of multiple PSKs.

In one embodiment, the list of multiple PSKs is securely transmitted from the controller 208 to the Access Points 204 in the wireless network 202 on initial connection of the Access Points 204. In one configuration, if the list of multiple PSKs is updated, the updated list of multiple PSKs is sent to the Access Points 204. In an alternative configuration, the Access Points 204 may maintain only a list of currently valid PSKs, which would be updated by the controller 208 whenever a PSK becomes currently valid or invalid. For instance, the controller 208 may simply provide an instruction to add or delete a particular PSK as opposed to re-sending the entire list of multiple PSKs each time there is an update.

One of ordinary skill in the art will understand that the wireless network 202 may be any wireless network known to one skilled in the art. For instance, the wireless network 202 may be an IEEE 802.11 network.

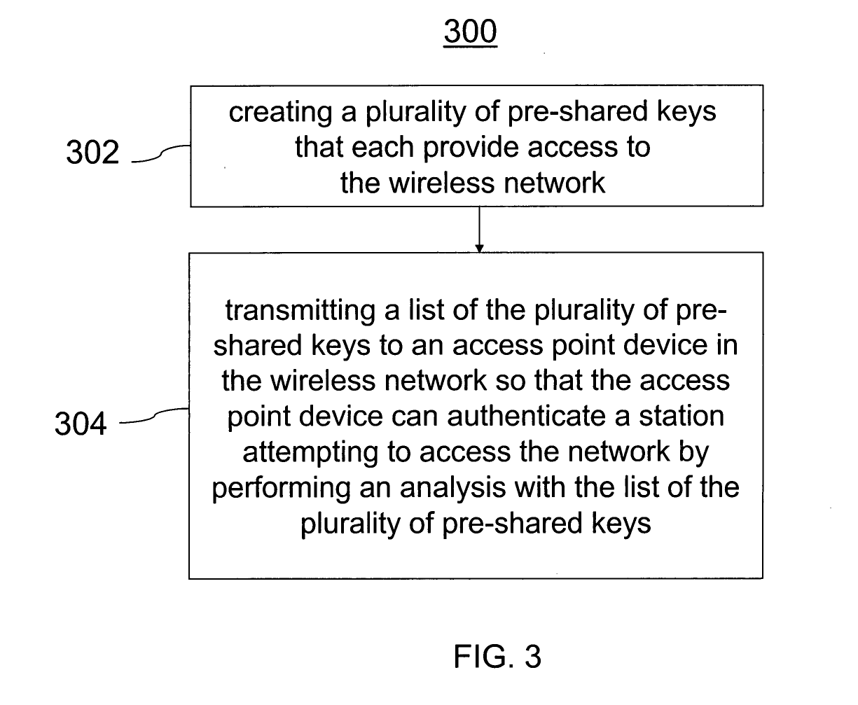

FIG. 3 illustrates a process 300 in which a list of multiple PSKs is generated. At a process block 302, a plurality of pre-shared keys are created. Each of the plurality of pre-shared keys provides access to the wireless network. At a process block 304, a list of the plurality of pre-shared keys is transmitted to an access point device in the wireless network. The access point device can authenticate a station attempting to access the network by performing an analysis with the list of the plurality of pre-shared keys.

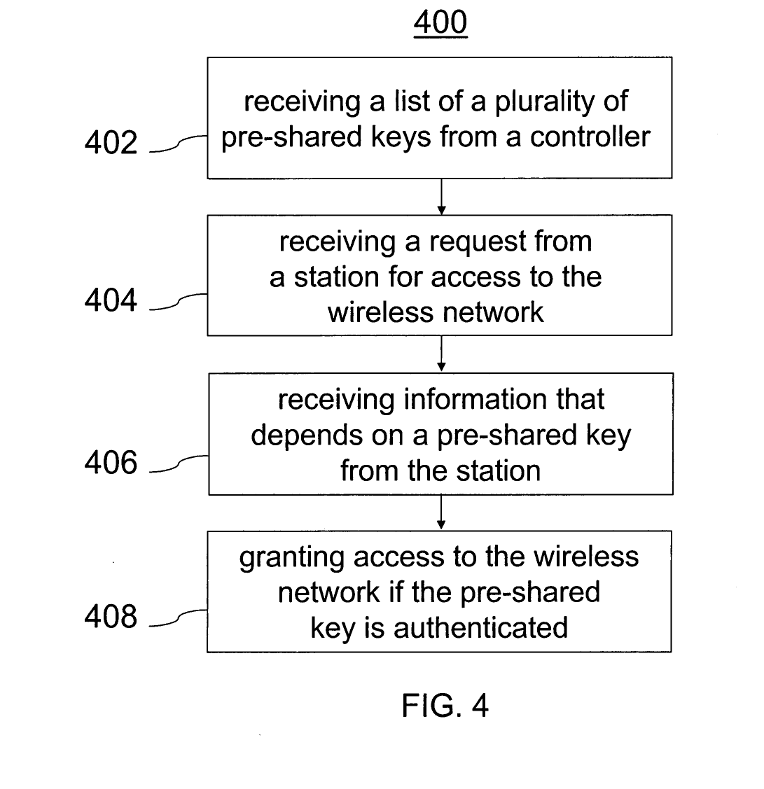

FIG. 4 illustrates a process 400 in which a pre-shared key is authenticated. At a process block 402, a list of a plurality of pre-shared keys is received from a controller. Further, at a process block 404, a request is received from a station. The request is for access to the wireless network. In addition, at a process block 406, information that is dependent on a station pre-shared key is received from the station. At a process block 408, access is granted to the wireless network if the pre-shared key is authenticated.

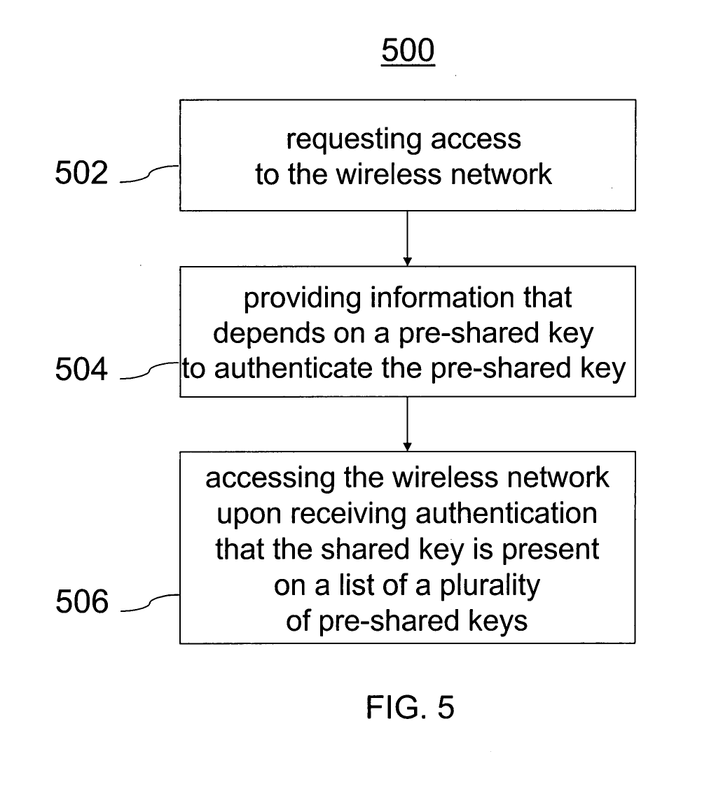

FIG. 5 illustrates a process 500 for accessing a wireless network. At a process block 502, access to the wireless network is requested. Further, at a process block 504, information that is dependent on a pre-shared key to be authenticated is provided. In addition, at a process block 506, the wireless network is accessed upon receiving authentication that the shared key is present on a list of a plurality of pre-shared keys.

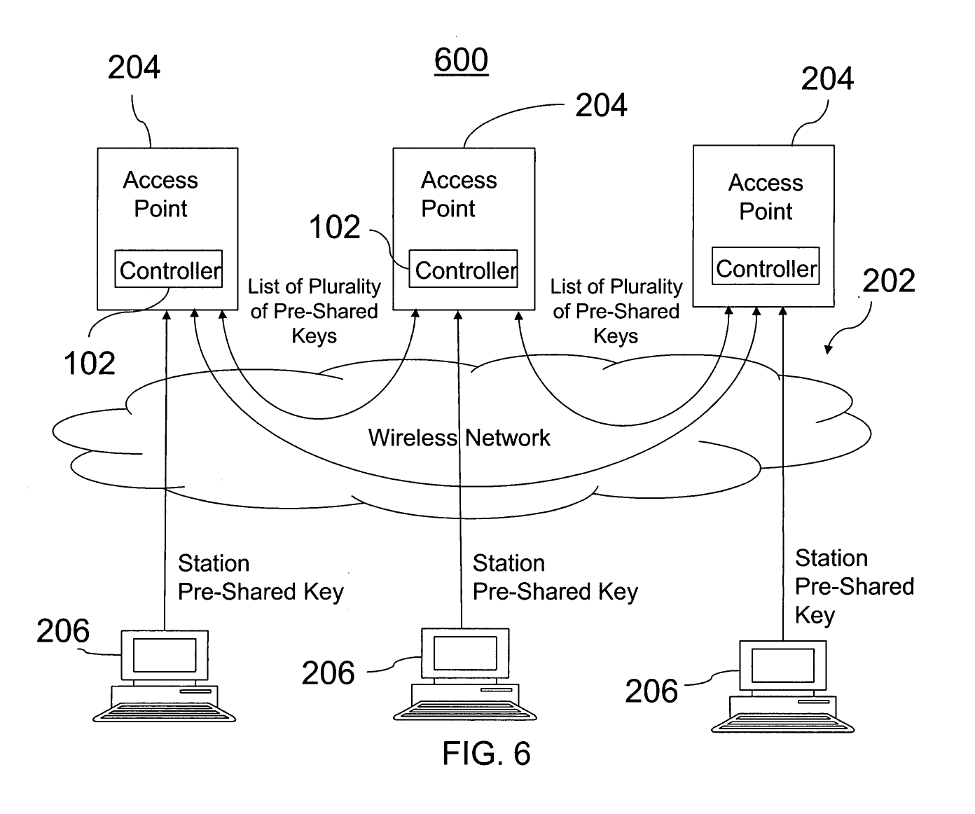

FIG. 6 illustrates a system 600 in which the controller 208 is incorporated into the Access Point 204. The list of multiple PSKs is maintained at the Access Point 204 and is transmitted between the various Access Points 204. In one embodiment, the list of multiple PSKs is transmitted between the Access Points 204 through the wireless network 202. For instance, messages containing data for the list of multiple PSKs may be transmitted between the various Access Points 204.

The list of multiple PSKs may also have communications service restriction information. For example, check boxes may be used to indicate access to the Internet and to local stations. In another configuration, communications access to local nodes could be controlled per node based on station medium access control (“MAC”) address, or PSK, or the like.

In another embodiment, the Access Points 204 maintain a list of the PSKs that are currently valid. The list of the currently valid PSKs would be updated by the controller 208 whenever a PSK becomes currently valid or invalid. The list can be updated from the controller 208, which is not incorporated into the Access Point 204. Alternatively, the list of PSKs can be updated by the controller 208 which is incorporated into the Access Point 204.

A network based on IEEE 802.11 can be modified to provide the methodologies discussed above. The 802.11 logic in the Access Points 204 can be modified to store multiple PSKs. When the station 206 attempts to connect to one of the Access Points 204, the station 206 indicates that the user station 206 is using a PSK. As a result of this indication, the IEEE 802.1X network access control is bypassed and a four way handshake occurs.

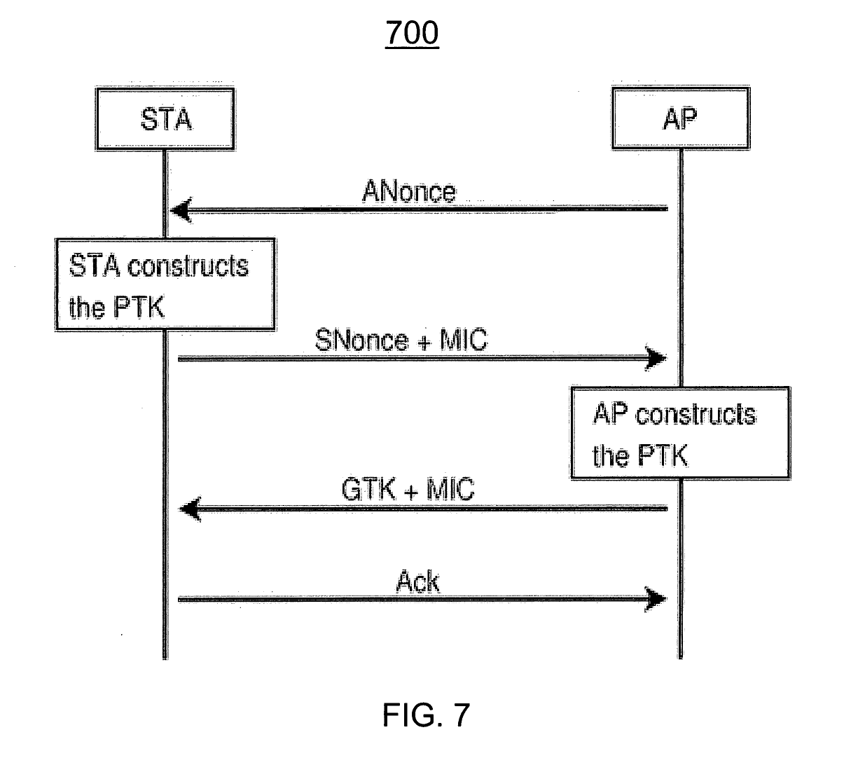

FIG. 7 illustrates a four way hand shake process. In 802.1X, after the Supplicant (station, STA), communicating through the Authenticator (Access Point 204), is authenticated by the Authentication Server (AS) with an appropriate method, the station 206 and AS then share a key called the Pairwise Master Key (“PMK”). The AS then gives the PMK to the Access Point 204 based on a prior trust relationship between them, in 802.1X. Based on the PMK, the station 206 and the Access Point 204 start a four-way handshake to derive the PTK (Pairwise Transient Key) and transmit the GTK (Group Temporal Key) to the station. When a PSK is used for authentication, 802.1X is bypassed and the PSK is used as the PMK.

The authentication process above leaves two considerations: the Access Point 204 and the STA 206 need to authenticate each other and keys to encrypt the traffic needs still need to be derived. The earlier 802.1X EAP exchange has provided the shared secret key PMK (Pairwise Master Key). This key is however designed to last the entire session, is known to 3 parties, and should be exposed as little as possible. Alternatively, a PSK with a potentially very long lifetime is being used as the PMK and should also be minimally exposed. Therefore the four-way handshake is used to establish another key called the PTK. The PTK is generated by concatenating the following attributes: PMK, a randomly generated number that is used only once (“nonce”) from Access Point 204 (“ANonce”), STA nonce (“SNonce”), Access Point 204 MAC address and STA MAC address. The resulting concatenation is then put through a cryptographic hash (pseudo-random) function.

Successful communication with the PTK proves that the two parties, the mobile user station 206 and the Access Point 204, are live and mutually authenticated.

The handshake also transmits the GTK, used to decrypt multicast and broadcast traffic, from the Access Point 204. The actual messages exchanged during the 802.11 handshake are illustrated in FIG. 7.

First, the Access Point 204 sends a nonce-value to the STA (ANonce). The client now has all the information to construct the PTK. Second, the STA sends its own nonce-value (SNonce) to the Access Point 204 together with a MIC (Message Integrity Code). Third, the Access Point 204 uses SNonce to derive PTK and verifies the MIC from the mobile station. The Access Point 204 then sends the GTK and a sequence number together with another MIC. The sequence number is the sequence number that will be used in the next multicast or broadcast frame, so that the receiving STA can perform basic replay detection. Fourth, the STA sends a confirmation to the Access Point 204 so that all parties will know that set up is complete.

As soon as the PTK is obtained, the PTK is divided into three separate keys. The first key is the EAPOL-Key Confirmation Key (“KCK”). The KCK is the key used to compute the MIC for EAPOL-Key packets. The second key is the EAPOL-Key Encryption Key (“KEK”). The KEK is the key used to provide confidentiality for EAPOL-Key packets. The third key is the Temporal Key (“TK”). The TK is the key used to encrypt the actual wireless traffic.

The IEEE 802.11 network is modified so that when the Access Point 204 receives message two from the user station 206, the Access Point 204 attempts to utilize PSKs from the list of PSKs to validate the Message Integrity Code (“MIC”) until one of the PSKs validates the message or all of the PSKs fail to validate the MIC. In the first case, the handshake completes, access is granted, and the Access Point 204 remembers which PSK validated this MIC for that station. In the second, access is denied. Should the PSK that was used to approve access for a station be deleted from the list at an Access Point 204 with which that station is associated, the association should be eliminated. Additional logic can be added to the Access Points 204 if communications restrictions based on PSK are also to be imposed.

Using 802.11i Robust Secure Network (RSN) security, a different unicast session key is used by the Access Point for each station as derived from the four-way handshake. This situation is simple for the user station 206, which needs to only look at the Key ID bits, but a bit more complex for the Access Point 204. The Access Point 204 needs to look at the Key ID and the source MAC address to determine what key to use. In the presence of an Access Point 204 with which they are associated, stations 206 need to look at the source MAC address only for the purpose of dropping all frames that are not from the Access Point 204.

A single session key, the GTK, is used by an Access Point 204 for all broadcast traffic. This is initially given to each station during its four-way handshake with the Access Point 204. However, there are provisions for the Access Point 204 pushing out a new GTK by unicasting it to each authorized station whenever it chooses to do so. If there is a station which has the current GTK based on a PSK authentication and the validity of that PSK expires, that would be a good signal for the Access Point 204 to push out a new GTK and cut off the no longer authorized station from broadcast traffic.

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of providing security in a wireless network, the method comprising:
creating a plurality of pre-shared keys that each provide access to the wireless network; and
transmitting a list of the plurality of pre-shared keys to an access point device in the wireless network so that the access point device can authenticate a station attempting to access the network by performing an analysis with the list of the plurality of pre-shared keys.

2. The method of claim 1, wherein the analysis includes a determination as to the presence of a station pre-shared key on the list of the plurality of pre-shared keys.

3. The method of claim 2, further comprising assigning a start time to each of the plurality of pre-shared keys.

4. The method of claim 3, wherein the analysis includes a determination as to whether the start time has begun for the pre-shared key on the list of the plurality of pre-shared keys that matches with the station pre-shared key.

5. The method of claim 4, wherein the Access Point 204 grants the station access if the start time has begun.

6. The method of claim 2, further comprising assigning an end time to each of the plurality of pre-shared keys.

7. The method of claim 6, wherein the analysis includes a determination as to whether the end time has been reached for the pre-shared key on the list of the plurality of pre-shared keys that matches with the station pre-shared key.

8. The method of claim 7, wherein the Access Point 204 terminates access if the end time has been reached.

9. The method of claim 1, further comprising transmitting an updated list of the plurality of pre-shared keys to the access point device when the list of the plurality of pre-shared keys is changed.

10. The method of claim 9, wherein the list of the plurality of pre-shared keys is changed by adding a pre-shared key to the list of the plurality of pre-shared keys.

11. The method of claim 9, wherein the list of the plurality of pre-shared keys is changed by deleting a pre-shared key from the list of the plurality of pre-shared keys.

12. The method of claim 9, wherein the list of the plurality of pre-shared keys is changed by changing a start time associated with a pre-shared key in the list of the plurality of pre-shared keys.

13. The method of claim 9, wherein the list of the plurality of pre-shared keys is changed by changing an end time associated with a pre-shared key in the list of the plurality of pre-shared keys.

14. A method of providing access to a wireless network, comprising:
receiving a list of a plurality of pre-shared keys from a controller;
receiving a request from a station for access to the wireless network;
receiving information that is dependent on a station pre-shared key from the station;
authenticating the pre-shared key by performing an analysis on the information that is dependent on the pre-shared key and the list of the plurality of pre-shared keys; and
granting access to the wireless network if the pre-shared key is authenticated.

15. The method of claim 14, wherein the access is restricted to only a subset of services that are provided through the wireless network.

16. The method of claim 14, wherein the analysis includes determining if the pre-shared key is present in the list of the plurality of pre-shared keys.

17. The method of claim 14, wherein the analysis includes determining if a start date associated with the shared key has begun yet.

18. The method of claim 14, wherein the analysis includes determining if an end date associated with the shared key has been reached yet.

19. A method of securely accessing a wireless network, comprising:
requesting access to the wireless network;
providing information that is dependent on a pre-shared key to authenticate the pre-shared key; and
accessing the wireless network upon receiving authentication that the shared key is present on a list of a plurality of pre-shared keys.

20. The method of claim 19, wherein a subset of services based on attributes associated with the pre-shared key is provided through the wireless network.
